(19) United States
(12) Patent Application Publication
(10) Pub. No.: US 2026/0275596 A1
(43) Pub. Date: Sep. 17, 2026

(54) ELECTROSPUN SILICONE ELASTOMER NONWOVEN FABRIC

(71) Applicant: Wacker Chemie AG, München (DE)

(72) Inventors: Sabin-Lucian SURARU, München (DE); Torsten GOTTSCHALK-GAUDIG, München (DE)

(73) Assignee: Wacker Chemie AG, Munich (DE)

(21) Appl. No.: 19/168,334

(22) PCT Filed: Apr. 4, 2023
(86) PCT No.: PCT/EP2023/058729

§ 371 Date: Sep. 24, 2025

(51) Int. Cl. D04H 1/728; D01D 5/00

(52) U.S. Cl. CPC D04H 1/728; D01D 5/003; D10B 2331/30; D10B 2505/04

(57) ABSTRACT

An electrospinning solution includes at least one organic solvent, an addition-crosslinking silicone elastomer composition, and at least one polysiloxane having a viscosity greater than 5 000 000 mPa·s measured at 25° C. and a shear rate of 0.1 s⁻¹. The addition-crosslinking silicone elastomer composition includes at least one organopolysiloxane compound comprising radicals having aliphatic carbon-carbon multiple bonds, at least one organopolysiloxane compound having Si-bonded hydrogen atoms, or instead of (A) and (B) or in addition to (A) and (B), at least one organopolysiloxane compound comprising Si—C-bonded radicals having aliphatic carbon-carbon multiple bonds and Si-bonded hydrogen atoms. None of the components (A), (B) and (C) has a viscosity greater than 800 000 mPa·s measured at 25° C. and a shear rate of 0.1 s⁻¹. The addition-crosslinking silicone elastomer composition also includes at least one hydrosilylation catalyst and no filler or at least one silicon-containing filler.

The present invention relates to a silicone elastomer-based electrospinning solution and to the use thereof for producing nonwovens by electrospinning.

### PRIOR ART

Electrospinning is a process known in the prior art for producing nonwovens having a controllable fiber diameter of just a few micrometers to just a few nanometers. It comprises spinning a polymer melt, solution or dispersion into a fiber of sub-micrometer thickness in a strong electric field (about 10-50 kV) between the spinning nozzle (capillary) and the collector and depositing it on a substrate as a fiber nonwoven. The throughput of the method is achievable through simple numbering-up of the nozzles. Details of the electrospinning process are described for example in A. Greiner et al. Applied Chem. 2007, 119, 5770-5805. This document also discloses a multiplicity of examples of polymer classes that have already been employed in the electrospinning process. Electrospinning typically employs thermoplastics as a melt or dissolved in a suitable solvent as a solution.

Electrospun nonwovens are employed for example for filtration, for example in respirator masks for occupational and infection protection, and in air purifiers where the contaminated air is drawn through an air inlet opening in a container and passed through a series of filters by means of a blower. Fiber nonwovens having fiber diameters of just a few micrometers to just a few nanometers are particularly suitable for use as filter media since these exhibit a low pressure drop and a high filtration efficiency of the filter medium. The filtration is based inter alia on the large specific surface area of the nanofibers and the low pressure drop and thus breathing resistance is based on the high porosity of the corresponding fiber nonwoven. It is also known to use electrets to increase the filtration efficiency of air and respiratory filters. These are dielectric articles having a permanent charge. This property increases the ability of the filter medium to attract and retain particles such as for example dust, dirt and fibers present in the air. This is typically achieved using fluorinated polymers, ideally PTFE, since these have a particularly high tendency to absorb and store negative charges (negative end of the tribological series). Electrospinning is suitable for production of nanofibers with electret properties, since the employed electric field applies charges directly to the nonwoven. U.S. Pat. No. 8,801,998B (corresponding to EP2557206B1) describes for example an electret for filter applications made of electrospun PU fibers provided with PTFE nanoparticles.

Autoclavable or sterilizable filter media presuppose a corresponding stability of the filter medium toward temperature or ionizing radiation.

These therefore cannot employ standard plastics such as polyester or polypropylene but rather special, high-melting thermoplastics such as polyimide (PI) or polyether imide (PEI) are required. The resulting limited melting and solubility characteristics of these thermoplastics make their use for spinning processes costly and inconvenient. By contrast, silicone elastomers are temperature- or UV-crosslinkable systems. Prior to crosslinking, the base components are typically not only soluble in most aprotic solvents but also, due to their typically shear-thinning properties, pumpable and thus readily processable. After the crosslinking step, silicone elastomers exhibit a high mechanical flexibility and stability toward the effect of temperature and radiation. In addition, silicones which are found at the negative end of the triboelectric series are characterized by a particularly high electron affinity at the material surface and can therefore readily function as an electret.

The electrospinning of silicones is also known in the prior art and is typically effected from an organic solvent. In order to provide the spinning solution with the necessary viscoelasticity to form homogeneous fibers during electrospinning, it is prior art to add higher-molecular-weight, hydrophilic polymers to the spinning solution as thickeners. For example, CN109868559 discloses the successful electrospinning from ethanol of a crosslinkable silicone composition (composed of polymethylhydrogensiloxane, (DVi)₄ and H₂PtCl₆) in the presence of polyvinylpyrrolidone (PVP). Alternatively, silicones are suitable for coaxial electrospinning processes, wherein without preceding mixing these are electrospun together with immiscible, usually hydrophilic polymers to obtain core-shell fibers. The outer shell polymer serves as a template for the formation of fibers. The silicone is then found in the core of the electrospun fiber. By way of example, CN101498057 describes the coaxial electrospinning of a silicone rubber (core) together with PVP as a water-soluble polymer (shell). The silicone is dissolved in dichloromethane and the PVP in ethanol. To obtain silicone fibers, the shell polymer is removed with water in a subsequent step. US2014322512 (corresponding to WO2014143866) describes a needleless electrospinning process for producing silicone-PLGA core-shell fibers, wherein a flowable silicone elastomer is employed. The disadvantage is that, to obtain pure silicone fibers, the concomitant polymer requires removal in a step which follows the electrospinning process. This is typically done in an aqueous washing step.

It is accordingly an object of the present invention to provide silicone compositions which may be used in the electrospinning process even without concomitant polymers and thus no longer exhibit the aforementioned disadvantages of the prior art.

It has now been found, entirely surprisingly, that the present electrospinning solution according to the invention achieves this object. It is suitable for use in an electrospinning process for producing a nanofiber nonwoven composed entirely of silicone. The at least one organopolysiloxane (iii) present according to the invention, which has a sufficient molecular weight and thus a viscosity greater than 5 000 000 mPa·s (measured at 25° C. and a shear rate of 0.1 s⁻¹), is crucial since this component assumes the template effect to bring about formation of fibers. The organopolysiloxane (iii) may optionally also comprise suitable functional groups in order to be incorporated into the silicone elastomer network. Adding the organopolysiloxane (iii) to the electrospinning solution affords pure silicone fibers, thus rendering a subsequent washing step obsolete.

The present invention accordingly provides an electrospinning solution comprising
(i) at least one organic solvent and
(ii) an addition-crosslinking silicone elastomer composition comprising
   (A) at least one organopolysiloxane compound comprising radicals having aliphatic carbon-carbon multiple bonds,
   (B) at least one organopolysiloxane compound having Si-bonded hydrogen atoms,
   or instead of (A) and (B) or in addition to (A) and (B)
   (C) at least one organopolysiloxane compound comprising Si—C-bonded radicals having aliphatic carbon-carbon multiple bonds and Si-bonded hydrogen atoms,
      with the proviso that none of the components (A), (B) and (C) has a viscosity greater than 800 000 mPa·s measured at 25° C. and a shear rate of 0.1 s⁻¹,
   (D) at least one hydrosilylation catalyst,
   (E) no filler or at least one silicon-containing filler, and
(iii) at least one polysiloxane distinct from (A), (B), (C) and (E) having a viscosity greater than 5 000 000 mPa·s measured at 25° C. and a shear rate of 0.1 s⁻¹.

In order not to create an excessive number of pages in the description of the present invention, only the preferred embodiments of the individual features are specified hereinbelow.

However, the expert reader should explicitly understand this type of disclosure as meaning that every combination of different preference levels is also explicitly disclosed and explicitly desired.

### Organic Solvent (i)

Employable solvents include a single organic solvent or a mixture of different organic solvents. Suitable organic solvents include hydrocarbons, halogenated hydrocarbons, ethers, alcohols, aldehydes, ketones, acids, anhydrides, esters, N-containing solvents, S-containing solvents and organosilicon solvents.

Examples of common hydrocarbons include pentane, hexane, dimethylbutane, heptane, hex-1-ene, hexa-1,5-diene, cyclohexane, turpentine, benzene, isopropylbenzene, xylene, toluene, benzine, naphthalene and terahydronaphthalene. Examples of commonly used halogenated hydrocarbons include fluoroform, perfluoropheptane, methylene chloride, chloroform, carbon tetrachloride, 1,2-dichloroethane, 1,1,1-trichloroethane, tetrachloroethene, trichloroethene, pentyl chloride, bromoform, 1,2-dibromethane, methylene iodide, fluorobenzene, chlorobenzene and 1,2-dichlorobenzene. Examples of commonly used ethers include diethyl ether, butyl ethyl ether, anisole, diphenyl ether, ethylene oxide, tetrahydrofuran, furan, triethylene glycol and 1,4-dioxane. Examples of commonly used alcohols include methanol, ethanol, propanol, butanol, octanol, cyclohexanol, benzyl alcohol, ethylene glycol, ethylene glycol monomethyl ether, propylene glycol, butyl glycol, glycerol, glycerine, phenol and m-cresol. Examples of commonly used aldehydes include acetaldehyde and butyralaldehyde. Examples of commonly used ketones include acetone, diisobutyl ketone, butane-2-one, cyclohexanone and acetophenone. Commonly used examples of acids include formic acid and acetic acid. Commonly used examples of anhydrides include acetic anhydride and maleic anhydride. Commonly used examples of esters include methyl acetate, ethyl acetate, butyl acetate, phenyl acetate, glycerol tricarboxylate, diethyl oxalate, dioctyl sebacate, methyl benzoate, dibutyl phthalate, DBE® (DuPont de Nemours) and tricresyl phosphate. Commonly used examples of nitrogen-containing solvents include nitromethane, nitrobenzene, butyronitrile, acetonitrile, benzonitrile, malononitrile, hexylamine, aminoethanol, N,N-diethylaminoethanol, aniline, pyridine, N,N-dimethylaniline, N,N-dimethylformamide, N-methylpiperazine and 3-hydroxypropionitrile. Commonly used examples of sulfur-containing solvents include carbon disulfide, methanethiol, dimethyl sulfone, dimethyl sulfoxide and thiophene. Commonly used examples of organosilicon solvents include volatile, linear or cyclic siloxanes having at most five silicon atoms, in particular hexamethyldisiloxane, octamethyltrisiloxane, decamethyltetrasiloxane, hexamethylcyclotrisiloxane and octamethylcyclotetrasiloxane.

The electrospinning solution according to the invention preferably comprises 30% to 98% by weight, particularly preferably 50-95% by weight, of solvent (i).

### Addition-Crosslinking Silicone Elastomer Composition (ii)

The compounds (A) and (B) and/or (C) employed in the addition-crosslinking silicone elastomer composition (ii) according to the invention are known to be selected so as to allow crosslinking. For example, compound (A) thus has at least two aliphatically unsaturated radicals and (B) has at least three Si-bonded hydrogen atoms, or compound (A) has at least three aliphatically unsaturated radicals and siloxane (B) has at least two Si-bonded hydrogen atoms, or else, instead of compounds (A) and (B), siloxane (C) having aliphatically unsaturated radicals and Si-bonded hydrogen atoms in the abovementioned ratios is used. Mixtures of (A) and (B) and (C) having the abovementioned ratios of aliphatically unsaturated radicals and Si-bonded hydrogen atoms are also possible.

### Component (A)

The silicone compositions according to the invention preferably comprise as constituent (A) at least one aliphatically unsaturated organosilicon compound, it being possible to use all aliphatically unsaturated organosilicon compounds used to date in addition-crosslinking compositions, such as for example silicone block copolymers having urea segments, silicone block copolymers having amide segments and/or imide segments and/or ester amide segments and/or polystyrene segments and/or silarylene segments and/or carborane segments and silicone graft copolymers having ether groups.

Organosilicon compounds (A) used that comprise Si—C-bonded radicals having aliphatic carbon-carbon multiple bonds are preferably linear or branched organopolysiloxanes composed of units of the general formula (I)

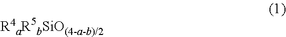

where
R⁴ independently at each occurrence is identical or different and is an organic or inorganic radical free of aliphatic carbon-carbon multiple bonds,
R⁵ independently at each occurrence is identical or different and is a monovalent, substituted or unsubstituted, Si—C-bonded hydrocarbon radical having at least one aliphatic carbon-carbon multiple bond,
a is 0, 1, 2 or 3, and
b is 0, 1 or 2,
with the proviso that the sum total of a+b is less than or equal to 3 and there are at least 2 radicals R⁵ per molecule.

Radical R⁴ may be mono- or polyvalent radicals, where the polyvalent radicals, such as bivalent, trivalent and tetravalent radicals, then connect multiple, for instance two, three or four, siloxy units of the formula (I) to one another.

Further examples of R⁴ are the monovalent radicals —F, —Cl, —Br, —OR⁶, —CN, —SCN, —NCO and Si—C-bonded, substituted or unsubstituted hydrocarbon radicals which may be interrupted by oxygen atoms or the group —C(O)—, and divalent radicals Si-bonded at both ends as per formula (I). If radical R⁴ is Si—C-bonded, substituted hydrocarbon radicals, preferred substituents are halogen atoms, phosphorus-containing radicals, cyano radicals, —OR⁶, —NR⁶—, —NR⁶2, —NR⁶—C(O)—NR⁶2, —C(O)—NR⁶2, —C(O)R⁶, —C(O)OR⁶, —SO₂—Ph and —C₆F⁵. In this case, R⁶ is independently at each occurrence identical or different and is a hydrogen atom or a monovalent hydrocarbon radical having 1 to 20 carbon atoms and Ph is the phenyl radical.

Examples of radicals R⁴ are alkyl radicals, such as the methyl, ethyl, n-propyl, isopropyl, n-butyl, isobutyl, tert-butyl, n-pentyl, isopentyl, neopentyl, tert-pentyl radical, hexyl radicals, such as the n-hexyl radical, heptyl radicals, such as the n-heptyl radical, octyl radicals, such as the n-octyl radical, and isooctyl radicals, such as the 2,2,4-trimethylpentyl radical, nonyl radicals, such as the n-nonyl radical, decyl radicals, such as the n-decyl radical, dodecyl radicals, such as the n-dodecyl radical, and octadecyl radicals, such as the n-octadecyl radical, cycloalkyl radicals, such as cyclopentyl, cyclohexyl, cycloheptyl and methylcyclohexyl radicals, aryl radicals, such as the phenyl, naphthyl, anthryl and phenanthryl radical, alkaryl radicals, such as o-, m-, p-tolyl radicals, xylyl radicals and ethylphenyl radicals, and aralkyl radicals, such as the benzyl radical, the α- and the β-phenylethyl radical.

Examples of substituted radicals R⁴ are haloalkyl radicals, such as the 3,3,3-trifluoro-n-propyl radical, the 2,2,2,2′,2′,2′-hexafluoroisopropyl radical, the heptafluoroisopropyl radical, haloaryl radicals, such as the o-, m- and p-chlorophenyl radical, —(CH₂)—N(R⁶)C(O)NR⁶₂, —(CH₂)ₙ—C(O)NR⁶₂, —(CH₂)ₒ—C(O)R⁶, —(CH₂)ₒ—C(O)OR⁶, —(CH₂)ₒ—C(O)NR⁶₂, —(CH₂)—C(O)—(CH₂)ₚC(O)CH₃, —(CH₂)—O—CO—R⁶, —(CH₂)—NR⁶—(CH₂)ₚ—NR⁶₂, —(CH₂)ₒ—O—(CH₂)ₚCH(OH) CH₂OH, —(CH₂)ₒ(OCH₂CH₂)ₚOR⁶, —(CH₂)ₒ—SO₂—Ph and —(CH₂)ₒ—O—C₆F₅, where R⁶ and Ph correspond to the definition given for them above and o and p are identical or different integers between 0 and 10.

Examples of R⁴ as divalent radicals Si-bonded at both ends as per formula (I) are those that derive from the monovalent examples given above for radical R⁴ in that there is an additional bond through substitution of a hydrogen atom; examples of such radicals are —(CH₂)—, —CH(CH₃)—, —C(CH₃)₂—, —CH(CH₃)—CH₂—, —C₆H₄—, —CH(Ph)—CH₂—, —C(CF₃)₂—, —(CH₂)ₒ—C₆H₄—(CH₂)ₒ—, — (CH₂)ₒ—C₆H₄—C₆H₄—(CH₂)ₒ—, —(CH₂O)ₚ, (CH₂CH₂O)ₒ, —(CH₂)ₒ—Oₓ—C₆H₄—SO₂—C₆H₄—Oₓ—(CH₂)ₒ—, where x is 0 or 1, and Ph, o and p have the definition given above.

Radical R⁴ is preferably a monovalent, Si—C-bonded, optionally substituted hydrocarbon radical that is free of aliphatic carbon-carbon multiple bonds and has 1 to 18 carbon atoms, particularly preferably a monovalent, Si—C-bonded hydrocarbon radical that is free of aliphatic carbon-carbon multiple bonds and has 1 to 6 carbon atoms, in particular the methyl or phenyl radical.

Radical R⁵ from formula (I) may be any desired groups that are amenable to an addition reaction (hydrosilylation) with an SiH-functional compound.

If radical R⁵ is Si—C-bonded, substituted hydrocarbon radicals, preferred substituents are halogen atoms, cyano radicals and —OR⁶, where R⁶ has the definition given above.

Radical R⁵ is preferably alkenyl and alkynyl groups having 2 to 16 carbon atoms, such as vinyl, allyl, methallyl, 1-propenyl, 5-hexenyl, ethynyl, butadienyl, hexadienyl, cyclopentenyl, cyclopentadienyl, cyclohexenyl, vinylcyclohexylethyl, divinylcyclohexylethyl, norbornenyl, vinylphenyl and styryl radicals, particular preference being given to the use of vinyl, allyl and hexenyl radicals.

The molecular weight of constituent (A) may vary within wide limits, for instance between 10² and 10⁶ g/mol. For example, constituent (A) may thus be an alkenyl-functional oligosiloxane of relatively low molecular weight, such as 1,2-divinyltetramethyldisiloxane, but also a high-polymeric polydimethylsiloxane having Si-bonded vinyl groups in chain or terminal positions, for example having a molecular weight of 10⁵ g/mol (number average determined by means of NMR). The structure of the molecules forming constituent (A) is not fixed either; in particular, the structure of a siloxane of relatively high molecular weight, i.e. an oligomeric or polymeric siloxane, may be linear, cyclic, branched or else resinous, network-like. Linear and cyclic polysiloxanes are preferably composed of units of the formula R⁴₃SiO_{1/2}, R⁵R⁴₂SiO_{1/2}, R⁵R⁴SiO_{1/2} and R⁴₂SiO_{2/2}, where R⁴ and R⁵ have the definition given above. Branched and network-like polysiloxanes additionally comprise trifunctional and/or tetrafunctional units, preference being given to those of the formulae R⁴SiO_{3/2}, R⁵SiO_{3/2} and SiO_{4/2}. It is of course also possible to use mixtures of different siloxanes that meet the criteria of constituent (A).

Particularly preferred as component (A) is the use of vinyl-functional, substantially linear polydiorganosiloxanes having a viscosity of 0.1 to 800 000 mPa·s, particularly preferably of 0.1 to 200 000 mPa·s, in each case at 25° C. measured in accordance with DIN EN ISO 3219:1994 and DIN 53019 using a calibrated cone-plate rheometer with a CP50-2 cone having an opening angle of 2° and a shear rate of 0.1 s⁻¹.

### Component (B)

Organosilicon compounds (B) used may be all hydrogen-functional organosilicon compounds that have also been used to date in addition-crosslinkable compositions.

Organopolysiloxanes (B) used that have Si-bonded hydrogen atoms are preferably linear, cyclic or branched organopolysiloxanes composed of units of the general formula (III)

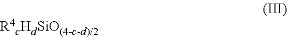

where
R⁴ has the definition given above,
c is 0,1, 2 or 3 and
d is 0, 1 or 2,
with the proviso that the sum total of c+d is less than or equal to 3 and there are at least two Si-bonded hydrogen atoms per molecule.

The organopolysiloxane (B) used according to the invention preferably comprises Si-bonded hydrogen in the range from 0.04 to 1.7 percent by weight, based on the total weight of the organopolysiloxane (B).

The molecular weight of constituent (B) may likewise vary within wide limits, for instance between 10² and 10⁶ g/mol. For example, constituent (B) may thus be an SiH-functional oligosiloxane of relatively low molecular weight, such as tetramethyldisiloxane, but also a high-polymeric polydimethylsiloxane having SiH groups in chain or terminal positions or a silicone resin having SiH groups.

The structure of the molecules forming constituent (B) is not fixed either; in particular, the structure of an SiH-containing siloxane of relatively high molecular weight, i.e. an oligomeric or polymeric SiH-containing siloxane, may be linear, cyclic, branched or else resinous, network-like. Linear and cyclic polysiloxanes (B) are preferably composed of units of the formula R⁴₃SiO_{1/2}, HR⁴₂SiO_{1/2}, HR⁴SiO_{2/2} and R⁴₂SiO_{2/2}, where R⁴ has the definition given above. Branched and network-like polysiloxanes additionally comprise trifunctional and/or tetrafunctional units, preference being given to those of the formulae R⁴SiO_{3/2}, HSiO_{3/2} and SiO_{4/2}, where R⁴ has the definition given above.

It is of course also possible to use mixtures of different siloxanes that meet the criteria of constituent (B). In particular, the molecules forming constituent (B) may optionally at the same time also comprise aliphatically unsaturated groups in addition to the obligatory SiH groups. Particular preference is given to the use of SiH-functional compounds of low molecular weight such as tetrakis(dimethylsiloxy)silane and tetramethylcyclotetrasiloxane, and SiH-containing siloxanes of relatively high molecular weight, such as poly(hydrogenmethyl)siloxane and poly(dimethylhydrogenmethyl)siloxane, having a viscosity at 25° C. of 10 to 20 000 mPa·s, measured in accordance with DIN EN ISO 3219:1994 and DIN 53019 using a calibrated cone-plate rheometer with a CP50-2 cone having an opening angle of 2° and a shear rate of 0.1 s⁻¹, or analogous SiH-containing compounds in which some of the methyl groups have been replaced by 3,3,3-trifluoropropyl or phenyl groups.

Constituent (B) is preferably present in the crosslinkable silicone compositions according to the invention in such an amount that the molar ratio of SiH groups to aliphatically unsaturated groups from (A) is 0.1 to 20, particularly preferably between 0.3 and 2.0.

Components (A) and (B) used according to the invention are commercially available products or can be produced by standard processes.

Instead of components (A) and (B), the silicone compositions according to the invention may comprise organopolysiloxanes (C) comprising at the same time aliphatic carbon-carbon multiple bonds and Si-bonded hydrogen atoms. It is also possible for the silicone compositions according to the invention to comprise all three components (A), (B) and (C).

### Component (C)

If siloxanes (C) are used, these are preferably those composed of units of the general formulae (IV), (V) and (VI)

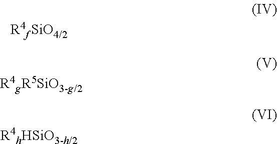

wherein
R⁴ and R⁵ have the definition given for them above, f is 0, 1,2 or 3,
g is 0, 1 or 2 and
h is 0, 1 or 2,
with the proviso that there are at least two radicals R⁵ and at least two Si-bonded hydrogen atoms per molecule.

Examples of organopolysiloxanes (C) are those composed of SiO_{4/2}, R⁴₃SiO_{1/2}, R⁴₂R⁵SiO_{1/2} and R⁴₂HSiO_{1/2} units, known as MQ resins, where these resins may additionally comprise R⁴SiO_{3/2} and R⁴₂SiO units, and linear organopolysiloxanes essentially consisting of R⁴₂R⁵SiO_{1/2}, R⁴₂SiO and R⁴HSiO units with R⁴ and R⁵ having the definition given above.

The organopolysiloxanes (C) preferably have an average viscosity of 0.01 to 800 000 Pa·s, particularly preferably 0.1 to 200 000 Pa·s, in each case at 25° C. measured in accordance with DIN EN ISO 3219:1994 and DIN 53019 using a calibrated cone-plate rheometer with a CP50-2 cone having an opening angle of 2° and a shear rate of 0.1 s⁻¹.

Organopolysiloxanes (C) are commercially available or can be produced by standard methods.

The addition-crosslinking silicone elastomer composition (ii) according to the invention typically comprises 30-95% by weight, preferably 30-80% by weight and particularly preferably 35-70% by weight of (A) based on the total mass of the addition-crosslinking silicone elastomer composition (ii).

The addition-crosslinking silicone elastomer composition (ii) according to the invention typically comprises 0.1-60% by weight, preferably 0.5-50% by weight and particularly preferably 1-40% by weight of (B) based on the total mass of the addition-crosslinking silicone elastomer composition.

If the addition-crosslinking silicone elastomer composition (ii) according to the invention comprises component (C), the formulation typically comprises 30-95% by weight, preferably 30-80% by weight, particularly preferably 40-70% by weight of (C) based on the total mass of the addition-crosslinking silicone elastomer composition (ii).

### Component (D)

Hydrosilylation catalysts (D) used may be all catalysts known from the prior art. Component (D) may be a platinum group metal, for example platinum, rhodium, ruthenium, palladium, osmium or iridium, an organometallic compound or a combination thereof. Examples of component (D) are compounds such as hexachloroplatinum(IV) acid, platinum dichloride, platinum acetylacetonate and complexes of said compounds encapsulated in a matrix or a core/shell-type structure. The platinum complexes with low molecular weight of the organopolysiloxanes include 1,3-diethenyl-1,1,3,3-tetramethyldisiloxane complexes with platinum. Further examples are platinum-phosphite complexes, platinum-phosphine complexes or alkyl-platinum complexes. These compounds may be encapsulated in a resin matrix. Suitable hydrosilylation catalysts (D) also include those that can be activated by electromagnetic radiation (UV, UV-VIS, IR). Such catalysts have likewise been known for a long time from the prior art. Examples thereof include (η-diolefin)(α-aryl)-platinum complexes (described for example in U.S. Pat. No. 6,046,250 corresponding to EP0561919B1), Pt(II) β-diketonate complexes (described for example in CA2014996A corresponding to EP0398701 B1) and (η⁵-cyclopentadienyl)tri(σ-alkyl)platinum(IV) complexes (described for example in U.S. Pat. No. 6,376,569 corresponding to EP0561893B1) and MeCpPtMe3 and the complexes derived therefrom by substitution of the groups coordinated to the platinum (described for example in U.S. Pat. No. 6,127,446 corresponding to EP1803728B1).

The concentration of component (D) in the addition-crosslinking silicone elastomer composition (ii) is sufficient for catalyzing the hydrosilylation reaction of components (A) and (B) on contact, in order to produce the heat required here in the process described. The amount of component (D) may be between 0.1 and 1000 parts per million (ppm), 0.5 and 100 ppm or 1 and 50 ppm of the platinum group metal, depending on the total weight of the components. The curing rate may be low if the constituent of the platinum group metal is below 1 ppm. The use of more than 100 ppm of the platinum group metal is uneconomic or may lower the stability of the adhesive formulation.

In the case of two-component systems, use is preferably made of the Karstedt catalyst (=platinum-1,3-divinyl-1,1,3,3-tetramethyldisiloxane complex). In one-component systems, use is preferably made of platinum phosphite complexes such as are disclosed for example in US2009088524A corresponding to EP2050768 A.

### Component (E)

Employable components (E) include fillers such as pyrogenic or precipitated silica or resin-like, i.e. three-dimensional crosslinked, polyorganosiloxanes distinct from (A), (B) and (C). Preference is given to reinforcing fillers such as pyrogenic or precipitated silicas having BET surface areas between 50 m²/g and 400 m²/g, wherein pyrogenic and precipitated silicas having BET surface areas of between 100 m²/g and 300 m²/g are particularly preferably employed. The silica fillers mentioned may have hydrophilic character or be hydrophobized by known methods.

It is preferable to employ surface-treated silicas (E). The surface treatment is achieved by the processes known in the prior art for hydrophobizing finely divided fillers.

As a result of a surface treatment, preferred fillers (E) have a carbon content of at least 0.01% to at most 20% by weight, preferably between 0.1% and 10% by weight, particularly preferably between 0.5% and 5% by weight. Particular preference is given to crosslinkable addition-crosslinking silicone elastomer compositions (ii) that are characterized in that the filler (E) is a surface-treated silica comprising 0.01% to 2% by weight of Si-bonded, aliphatically unsaturated groups. By way of example, these are Si-bonded vinyl groups.

The three-dimensionally crosslinked polyorganosiloxanes distinct from (A), (B) and (C) which are likewise preferred as constituent (E) are so-called organosiloxane resins constructed from units of general formulae (VII), (Vill), (IX) and (X)

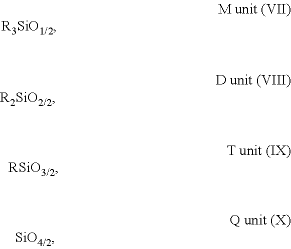

in which
R is selected from R¹, R², OH and OR²,
and with the proviso that
at least 20 mol % of the units are selected from units of general formulae (IX) and (X), and at most 2% by weight of the radicals R are OH.

R¹ is selected from identical or independently different monohydric organofunctional hydrocarbon radicals, unsaturated hydrocarbon radicals or a hydrogen radical, wherein the radical R¹ is bonded to the silicon atom via a carbon atom and the hydrogen radical is directly bonded to the silicon atom. It is preferable when R¹ is an alkenyl group or hydrogen radical. R¹ is particularly preferably a vinyl group.

R² is selected from identical or independently different monohydric hydrocarbon residues (alkyl, aryl, aralkyl).

Examples of unsubstituted radicals R² include alkyl radicals, such as the methyl, ethyl, n-propyl, isopropyl, n-butyl, isobutyl, tert-butyl, n-pentyl, isopentyl, neopentyl, tert-pentyl radical, hexyl radicals, such as the n-hexyl radical, heptyl radicals, such as the n-heptyl radical, octyl radicals, such as the n-octyl radical, and isooctyl radicals, such as the 2,2,4-trimethylpentyl radical, nonyl radicals, such as the n-nonyl radical, decyl radicals, such as the n-decyl radical; alkenyl radicals, such as the vinyl, allyl, n-5-hexenyl, 4-vinylcyclohexyl and the 3-norbornenyl radical; cycloalkyl radicals, such as cyclopentyl, cyclohexyl, 4-ethylcyclohexyl, cycloheptyl radicals, norbornyl radicals and methylcyclohexyl radicals; aryl radicals, such as the phenyl, biphenylyl, naphthyl radical; alkaryl radicals, such as o-, m-, p-tolyl radicals and ethylphenyl radicals; aralkyl radicals, such as the benzyl radical, the alpha- and the β-phenylethyl radical.

Examples of substituted hydrocarbon radicals as radicals R² are halogenated hydrocarbons, such as the chloromethyl, 3-chloropropyl, 3-bromopropyl, 3,3,3-trifluoropropyl and 5,5,5,4,4,3,3-heptafluoropentyl radical, and the chlorophenyl, dichlorophenyl and trifluorotolyl radical.

R² preferably comprises 1 to 6 carbon atoms. Methyl and phenyl are especially preferred.

The preferred radicals R are methyl, ethyl, phenyl and vinyl.

These organosiloxane resins (E) preferably comprise at least 30 mol %, in particular at least 40 mol % and preferably at most 80 mol %, in particular at most 70 mol %, of units of general formulae (IX) and (X).

These organosiloxane resins (E) are preferably MQ silicone resins (MQ), which comprise at least 80 mol %, preferably at least 95 mol %, in particular at least 97 mol %, of units of general formulae (VII) and (X). The average ratio of the units of the general formulae (VII) to (X) is preferably at least 0.25, in particular at least 0.5, and preferably 2, in particular at most 1.5.

It is preferable when at most 1% by weight, in particular at most 0.5% by weight, of the radicals R represent OH.

It is preferable when at least 0.01 mol %, particularly preferably at least 0.05 mol %, and preferably at most 8 mol %, in particular at most 5 mol %, of the radicals R represent R¹.

The average molecular weight Mn of the organosiloxane resins (E) is preferably at least 200 g/mol, in particular at least 1000 g/mol, and preferably at most 100 000 g/mol, in particular at most 20 000 g/mol.

In the addition-crosslinking silicone composition (ii) according to the invention, constituent (E) is preferably employed as an individual filler or likewise preferably as a mixture of two or more finely divided fillers.

The addition-crosslinking silicone elastomer composition (ii) according to the invention preferably comprises 0% to 45% by weight of (E), particularly preferably 0-35% by weight of (E).

The addition-crosslinking silicone compositions according to the invention may optionally comprise all further additives that are known to those skilled in the art of addition-crosslinking compositions from the prior art. These additives may include, for example, rheological additives, inhibitors, light stabilizers, flame retardants, dispersing aids, heat stabilizers, etc.

For clarity, it is noted that the employed amounts of each individual component of the silicone composition (ii) are selected such that they always sum to 100% by weight.

Component (iii)

Component (iii) is a polysiloxane distinct from (A), (B), (C) and (E) having a viscosity greater than 5 000 000 mPa·s measured at 25° C. and a shear rate of 0.1 s⁻¹.

The polysiloxane in component (iii) is predominantly linear with just a few branches, if any, wherein the content of T and Q units does not exceed the maximum value of 500 ppm. Such polysiloxanes have long been known to those skilled in the art. T units are described above for example with general formula (IX) and Q units are described with general formula (X).

The polysiloxane of component (iii) is preferably selected from organopolysiloxanes composed of units of general formula (XI)

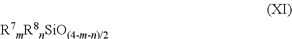

wherein
R⁷ independently at each occurrence is identical or different and is an organic or inorganic radical free of aliphatic carbon-carbon multiple bonds,
R⁸ independently at each occurrence is identical or different and is a monovalent, substituted or unsubstituted, Si—C-bonded hydrocarbon radical having at least one aliphatic carbon-carbon multiple bond,
m is 0, 1, 2 or 3 and
n is 0, 1 or 2,
with the proviso that the sum of m+n is less than or equal to 3.

R⁷ is preferably alkyl or aryl, particularly preferably methyl or phenyl.

R⁸, if present, is preferably a vinyl group. The vinyl group may be terminal or in the polysiloxane chain. Preference is given to a predominantly linear polysiloxane (iii). Particular preference is given to a predominantly linear polysiloxane (iii) which comprises vinyl units both terminally (as an M^{Vi} unit) and in the polysiloxane chain (as a D^{Vi} unit).

The polysiloxane (iii) may also be completely free of R⁸.

Component (iii) has a vinyl group content of 0 to 20 mol %. A vinyl group content of 0 to 2 mol % is preferred.

One (iii) or a mixture of two or more (iii) may be employed.

The electrospinning solution according to the invention preferably comprises 1% to 40% by weight of (iii), particularly preferably 1-25% by weight of (iii).

For clarity, it is noted that the employed amounts of the components (i), (ii) and (iii) of the electrospinning solution according to the invention are selected such that they always sum to 100% by weight.

The present invention thus further provides a process for producing nonwovens, wherein
in the first step all components are mixed such that the electrospinning solution according to the invention is in the form of a solution and
in a second step a nonwoven made of fibers of pure silicone elastomers is produced from this solution by electrospinning.

In a third step, the fibers may be cured, either thermally or by electromagnetic irradiation.

Depending on the embodiment, the first step (producing the electrospinning solution) may be performed offset in time or immediately before the second step (electrospinning).

Production of the electrospinning solution in the first step may be carried out in one or more individual steps. Components (i), (ii) and (iii) may be mixed in any sequence and combination. Components (ii) and (iii) may thus be partially or completely dissolved in (i) simultaneously or separately and the two pre-solutions subsequently mixed to give one solution.

However, individual constituents of the silicone elastomer composition (ii) may also be separately mixed with (iii) or (i). This especially encompasses 2-component silicones where components (A), (B) and (D) are often not present together. For the electrospinning solution, this may mean for example that the components (A), (D) and parts of (E) are mixed with (iii) and (i) in one or more steps and separately therefrom the components (B) and parts of (E) are mixed with (iii) and (i) in one or more steps.

When the silicone composition (ii) comprises component (E), i.e. a filler, it may be advantageous to initially disperse said filler in at least one component from (ii) or in (iii). This is preferably effected in at least one component from (ii). This dispersion step is preferably carried out with a high-speed mixer (=dissolver), wherein it is additionally preferably possible to employ a scraper to achieve an even distribution of the fillers. It is preferable to use a planetary dissolver having a scraper. Dissolver disks having any desired arrangement and number of teeth may be used.

Mixing apparatuses suitable for dissolving any components from (ii) or (iii) in the solvent (i) include mixing apparatuses of any kind such as for example magnetic stirrers, KPG stirrers, centrifugal mixers, planetary mixers or high-speed mixers.

The second step, the electrospinning process of the solution, is known in the prior art and is described in detail in WO2014114501 for example.

The third step, the crosslinking of the fibers, is preferably carried out thermally, preferably at 30° C. to 250° C., preferably at at least 50° C., in particular at at least 100° C., preferably at 120-210° C. The thermal curing is effected for example via a heatable collector using infrared radiation of wavelength 780 nm to 1 mm or a furnace. If UV-switchable hydrosilylation catalysts (D) are employed, the crosslinking is effected by irradiation with light of wavelength 230-400 nm preferably for at least 1 second, particularly preferably at least 5 seconds and preferably at most 500 seconds, particularly preferably at most 240 seconds. If IR-switchable hydrosilylation catalysts (D) are employed, this is analogously effected with infrared radiation of wavelength 780 nm to 1 mm, however.

If the crosslinking of the fibers is effected with photoinitiators, the fibers are preferably irradiated with light for at least 1 second, particularly preferably at least 5 seconds and preferably at most 500 seconds, particularly preferably at most 240 seconds.

Crosslinking with photoinitiators may be carried out under protective gas, for example N₂ or Ar, or in air.

The irradiated fibers are optionally thermally after treated after irradiation with light and then heated for preferably at most 1 hour, particularly preferably at most 10 minutes, in particular at most 1 minute, to effect curing.

The crosslinking is particularly preferably carried out under UV radiation, especially at 254 nm.

The present invention further provides the crosslinked nonwovens according to the invention produced by the process according to the invention.

The present invention further provides for the use of the crosslinked nonwovens according to the invention as a coating of three-dimensional articles, in wound plasters, in packaging materials and in filters and membranes.

The nonwovens according to the invention are suitable as a coating for three-dimensional articles to alter their surface properties in respect of, for example, sound or thermal insulation or shock absorption. The breathability achievable with the coating may be a desired additional property. It is preferable when housings, building materials or textiles are coated or laminated with the nonwovens according to the invention.

In addition, the nonwovens according to the invention may preferably also be employed in wound plasters.

The nonwovens according to the invention may also be used as a bacteriophobic and/or antimicrobial coating.

It is likewise preferable to employ the nonwovens according to the invention in packaging materials, especially in the packaging of foodstuffs. The nonwovens according to the invention are also suitable as a coating of containers for storing liquids, thus allowing the containers to be completely emptied.

The nonwovens according to the invention are particularly preferably likewise employable in garments, for example jackets, gloves, hats or shoes, or as roofing membranes. The nonwovens according to the invention are water-repellent and breathable.

The nonwovens according to the invention may particularly preferably also be utilized as filter media, for example for air filters or for separating particles from gas or liquid streams. The nonwovens according to the invention may especially also be used as filter media in respirator masks, for example in FFP3 and FFP2 masks.

The nonwovens according to the invention may also be used as membranes for separation of mixtures, such as reverse osmosis, gas separation, pervaporation, nanofiltration, ultrafiltration or microfiltration. It is possible to separate solid-solid, gaseous-gaseous, solid-gaseous or liquid-gaseous mixtures, and in particular liquid-liquid, solid-gaseous and liquid-solid mixtures. If the nonwovens according to the invention are employed as membranes, they may be assembled into the commonly used modules, for example into hollow fiber modules, spiral-wound winding modules, plate modules, cross-flow modules or dead-end modules.

The nonwovens according to the invention may likewise be used as a carrier or support layer for other membranes.

### EXAMPLES

The examples that follow describe how the present invention may be performed in principle but without limiting said invention to what is disclosed therein.

In the examples which follow, all figures for parts and percentages, unless stated otherwise, are based on weight. Unless stated otherwise, the examples which follow are conducted at a pressure of the surrounding atmosphere, i.e. at about 1000 hPa, and at room temperature, i.e. about 25° C., or a temperature which is established on combination of the reactants at room temperature without additional heating or cooling.

### Starting Materials

Employed Vinyl Polymer (iii):

Dimethylvinylsilyloxy-terminated dimethylsiloxane-methylvinylsiloxane copolymer comprising 0.1 mol % of vinyl groups and having a viscosity of 30 000 000 mPas at 25° C. and a shear rate of
0.1 s⁻¹. The molecular weight M_{w} (mass-average molar mass determined by GPC) is 600 000 g/mol.

### Employed Addition-Crosslinking Silicone Elastomer Compositions (ii):

As silicone composition 1, a UV-crosslinking silicone rubber composition according to Example 6 in US2018208797A (corresponding to WO 2017/089496 A1) was produced.

As silicone composition 2, a thermally-crosslinking silicone composition according to Example 6 in US2018208797A corresponding to WO2017/089496 A1 was produced, wherein, instead of the recited UV-activatable platinum catalyst, a thermally activatable platinum complex suitable for one-component systems and having phosphite ligands was selected, as described in US2009088524 A (corresponding to EP2050768B1) (catalyst 6).

The two-component, thermally crosslinking silicone elastomer LUMISIL® LR 7601/60 obtainable from Wacker Chemie AG was used as silicone composition 3.

### Employed Solvents (i):

n-butyl acetate (acetic acid n-butyl ester)
chloroform

### Viscosity Measurement:

The viscosity measurements were performed on an air-bearing-mounted MCR 302 rheometer from Anton Paar at 25° C. A cone/plate system (25 mm, 2°) with a gap size of 105 μm was used. The excess material was removed (trimmed) with a spatula at a gap distance of 115 μm. The cone was then moved to a gap distance of 105 μm so as to fill the entire gap. Before each measurement, a “pre-shear” is performed in which the shear history resulting from sample preparation, application and trimming is erased. The pre-shear is performed for 60 seconds at a shear rate of 0.1 s⁻¹, followed by a rest period of 300 seconds. The shear viscosity is determined by means of a step profile in which the sample is sheared at a constant shear rate of 0.1 s⁻¹ and 1 s⁻¹ for 100 seconds in each case. A reading is recorded every 10 seconds, resulting in 10 measurement points per shear rate. The average of these 10 measurement points gives the shear viscosity at the respective shear rate.

### EXEMPLARY EMBODIMENTS

### Example 1—Production of Solution 1

30 g of the silicone composition 1 were dissolved in 60 g of n-butyl acetate.

Subsequently, 10 g of the vinyl polymer were added and dissolved.

### Example 2—Production of Solution 2

30 g of the silicone composition 2 were dissolved in 60 g of n-butyl acetate.

Subsequently, 10 g of the vinyl polymer were added and dissolved.

### Example 3—Production of Solution 3

30 g of the A component of the elastomer LUMISIL® LR 7601/60 A were dissolved in 60 g of n-butyl acetate. Subsequently, 10 g of the vinyl polymer were added and dissolved. Separately, 30 g of the B component of the elastomer LUMISIL® LR 7601/60 B were dissolved in 60 g of n-butyl acetate and subsequently 10 g of the vinyl polymer were added and dissolved. Both components were combined in a ratio of 1:1 and immediately afterward employed as an electrospinning solution.

### Example 4—Production of Solution 4

30 g of the silicone composition 2 were dissolved in 62 g of n-butyl acetate.

Subsequently, 8.0 g of the vinyl polymer were added and dissolved.

### Example 5—Production of Solution 5

30 g of the silicone composition 2 were dissolved in 55 g of n-butyl acetate.

Subsequently, 15 g of the vinyl polymer were added and dissolved.

### Example 6—Production of Solution 6

20 g of the silicone composition 2 were dissolved in 76 g of chloroform. Subsequently, 4.0 g of the vinyl polymer were added and dissolved.

### Example 7 (Noninventive)—Production of Solution 7

30 g of the silicone composition 2 were dissolved in 70 g of n-butyl acetate.

### Electrospinning:

The electrospinning process was performed analogously to WO2014114501. To this end, the corresponding solution 1 to 7 was spun on an electrospinning system under the following conditions:
Voltage: 22.5 kV direct current
Distance between cannula and electrode: 40 cm
Cannula diameter: 1 mm
Flow rate: 5 mL/h

The substrate employed was aluminum foil. The electrode was either static or was rotated using an electric motor. After the completed electrospinning process, the sample comprising the deposited silicone material and the aluminum foil was subjected to photochemical aftertreatment using UV radiation or thermal aftertreatment. If silicone composition 2 or 3 (solutions 2 to 7) was used the sample was cured in the furnace at 150° C. for 20 min. If silicone composition 1 (solution 1) was used, the sample was irradiated with an Hg vapor lamp for 10 min.

Electrospinning of inventive solutions 1 to 6 afforded a fiber nonwoven composed of fibers in the sub-micro range. The diameter of the obtained fibers was determined by SEM.

Electrospinning of solution 7 (noninventive) afforded no fibers.

Table 1 shows an overview of the composition of the examples and the result of the electrospinning.

TABLE 1

| | Silicone | | Vinyl | | | |
|---|---|---|---|---|---|---|
| | composition | | polymer | | | Fiber diameter |
| Ex | (ii) | | (iii) | Solvents (i) | | [μm] |
| 1 | 1 | 30% by | 10% by | n-butyl acetate | 60% by | 0.7 |
| | | weight | weight | | weight | |
| 2 | 2 | 30% by | 10% by | n-butyl acetate | 60% by | 0.7 |
| | | weight | weight | | weight | |
| 3 | 3 | 30% by | 10% by | n-butyl acetate | 60% by | 0.6 |
| | | weight | weight | | weight | |
| 4 | 2 | 30% by | 8.0% by | n-butyl acetate | 62% by | 0.7 |
| | | weight | weight | | weight | |
| 5 | 2 | 30% by | 15% by | n-butyl acetate | 55% by | 0.7 |
| | | weight | weight | | weight | |
| 6 | 2 | 20% by | 4.0% by | chloroform | 76% by | 0.6 |
| | | weight | weight | | weight | |
| *7 | 2 | 30% by | — | n-butyl acetate | 70% by | no fibers |
| | | weight | | | weight | |

Ex = examples
*noninventive

1-10. (canceled)

11. An electrospinning solution comprising
(i) at least one organic solvent and
(ii) an addition-crosslinking silicone elastomer composition comprising
(A) at least one organopolysiloxane compound comprising radicals having aliphatic carbon-carbon multiple bonds,
(B) at least one organopolysiloxane compound having Si-bonded hydrogen atoms, or instead of (A) and (B) or in addition to (A) and (B)
(C) at least one organopolysiloxane compound comprising Si—C-bonded radicals having aliphatic carbon-carbon multiple bonds and Si-bonded hydrogen atoms,
with the proviso that none of the components (A), (B) and (C) has a viscosity greater than 800 000 mPa·s measured at 25° C. and a shear rate of 0.1 s⁻¹,
(D) at least one hydrosilylation catalyst,
(E) no filler or at least one silicon-containing filler, and
(iii) at least one polysiloxane distinct from (A), (B), (C) and (E) having a viscosity greater than 5 000 000 mPa·s measured at 25° C. and a shear rate of 0.1 s⁻¹.

12. The electrospinning solution as claimed in claim 11, wherein the content of organic solvent (i) is 30-98% by weight.

13. The electrospinning solution as claimed in claim 11, wherein the content of organic solvent (i) is 50-95% by weight.

14. The electrospinning solution as claimed in claim 11, wherein the content of polysiloxane (iii) is 1-40% by weight.

15. A process for producing nonwovens, wherein
in the first step all components as claimed in claim 11 are mixed such that the electrospinning solution according to the invention is in the form of a solution
and in a second step a nonwoven made of fibers of pure silicone elastomer composition is produced from this solution by electrospinning.

16. The process for producing nonwovens as claimed in claim 15, wherein
the fibers are cured in a third step.

17. The process for producing nonwovens as claimed in claim 15, wherein the curing is effected thermally or by electromagnetic irradiation.

18. A cured nonwoven produced by the process as claimed in claim 16.

19. A cured nonwoven produced by the process as claimed in claim 17.

20. The use of the nonwoven as claimed in claim 18 as a coating of three-dimensional articles, in wound plasters, in packaging materials and in filters and membranes.

21. The use of the nonwoven as claimed in claim 19 as a coating of three-dimensional articles, in wound plasters, in packaging materials and in filters and membranes.

22. The use of the nonwoven as claimed in claim 18 in filters and membranes.

23. The use of the nonwoven as claimed in claim 19 in filters and membranes.
